(19) United States
(12) Patent Application Publication
(10) Pub. No.: US 2015/0080131 A1
(43) Pub. Date: Mar. 19, 2015

(54) SYSTEMS AND METHODS TO PRESENT LOCATION-BASED LEADERBOARDS

(71) Applicant: Zynga, Inc., San Fracisco, CA (US)

(72) Inventors: John Bacon, San Francisco, CA (US); Jordan Knapp, San Francisco, CA (US); Christian Selchau-Hansen, Burlingame, CA (US); Kevin Keeker, San Francisco, CA (US)

(73) Assignee: Zynga, Inc., San Francisco, CA (US)

(21) Appl. No.: 14/031,460

(22) Filed: Sep. 19, 2013

(51) Int. Cl. A63F 13/30

(52) U.S. Cl. CPC A63F 13/12
USPC 463/42

(57) ABSTRACT

A system, computer-readable storage medium storing at least one program, and a computer-implemented method to present a location-based leaderboard is provided. A request to play a game against a second player is received, the request being received from a first client device of a first player and including a location of the first client device. A pre-defined location associated with the location of the first client device is determined. A game instance of the game is generated in response to the request. An outcome associated with the game is determined. The outcome of the game instance is published including publishing the outcome based on the pre-defined location.

### TECHNICAL FIELD

The present disclosure relates to games and applications in general and in particular to computer-implemented games, such as an online game hosted on a game server. In an example embodiment, a leaderboard may be presented for the online game.

### BACKGROUND

Many games may present a leaderboard displaying information regarding players of the game. The information may include a player name, or alias, along with a player's game achievements. The players of the game may be ranked in the leaderboard based on their game achievements.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 is a schematic diagram showing an example of a system, according to some embodiments;

FIG. 2 is a schematic diagram showing an example of a social network within a social graph, according to some embodiments;

FIG. 3 is a block diagram showing example components of a game networking system, according to some embodiments;

FIG. 4 is a flowchart showing an example method of presenting a location-based leaderboard to player, according to some embodiments;

FIG. 5 is a user interface diagram illustrating an example game user interface to select a game location from a map, according to some embodiments;

FIG. 6 is a user interface diagram illustrating an example user interface to choose an online game, according to some embodiments;

FIG. 7 is an interface diagram illustrating an example user interface of a leaderboard, according to some embodiments;

FIG. 8 is a diagrammatic representation of an example data flow between example components of the example system of FIG. 1, according to some embodiments;

FIG. 9 is a schematic diagram showing an example network environment, in which various example embodiments may operate, according to some embodiments; and

FIG. 10 is a block diagram illustrating an example computing system architecture, which may be used to implement one or more of the methodologies described herein, according to some embodiments.

### DESCRIPTION OF EXAMPLE EMBODIMENTS

### Overview

A player may initiate an instance of an online game which may be played against an opponent. In various embodiments, the online game is played on a mobile device of the player. The instance of the online game may be attached to a physical location, also referred to as a game location. In various embodiments, the online game can only be played at the attached game location. Therefore, if the player travels outside of the game location, the online game is no longer available to the player. The game location may be determined based on a location of the player's mobile device. For example, if the player is playing the online game on the mobile device while sitting in a coffee shop, the game location may correspond to the coffee shop. The game location may also be determined based on a location of the opponent. Therefore, if the opponent is playing the online game in a restaurant next to the coffee shop, the game location may correspond to an area including both the restaurant and the coffee shop. In various embodiments, the player selects the game location from a list of locations. The list of locations may be locations that are near the player. Further, the list of locations may be ranked according to various factors.

When the player is playing the instance of the online game, game data may be sent from the mobile device of the player to a game server. Game data may also be sent from a mobile device of the opponent to the game server. The game data may include information on interactions between the player and the online game, such as the player's moves in the online game, the player's score in the online game, and the like. After collecting the game data, the game server may determine an outcome based on the game data. The game server may publish the outcome on a leaderboard to players of the online game. For example, the leaderboard may display the player's score as well as scores of previous players of the online game. The leaderboard may also display a winner of the game instance. In various embodiments, the leaderboard is location-based and corresponds to the game location of the online game. Therefore, if the coffee shop is the game location attached to the game instance, the leaderboard for the game instance may correspond to the coffee shop. The game location may also be indicated or determined by various location characteristics, such as city, state, country, continent, and the like. In various embodiments, the leaderboard is used to challenge other players in the game instance of the online game. A user playing the online game may select a player to challenge from the leaderboard. In various embodiments, the game location and the leaderboard are stored on the game server and preserved after the player stops playing the online game.

### Example System

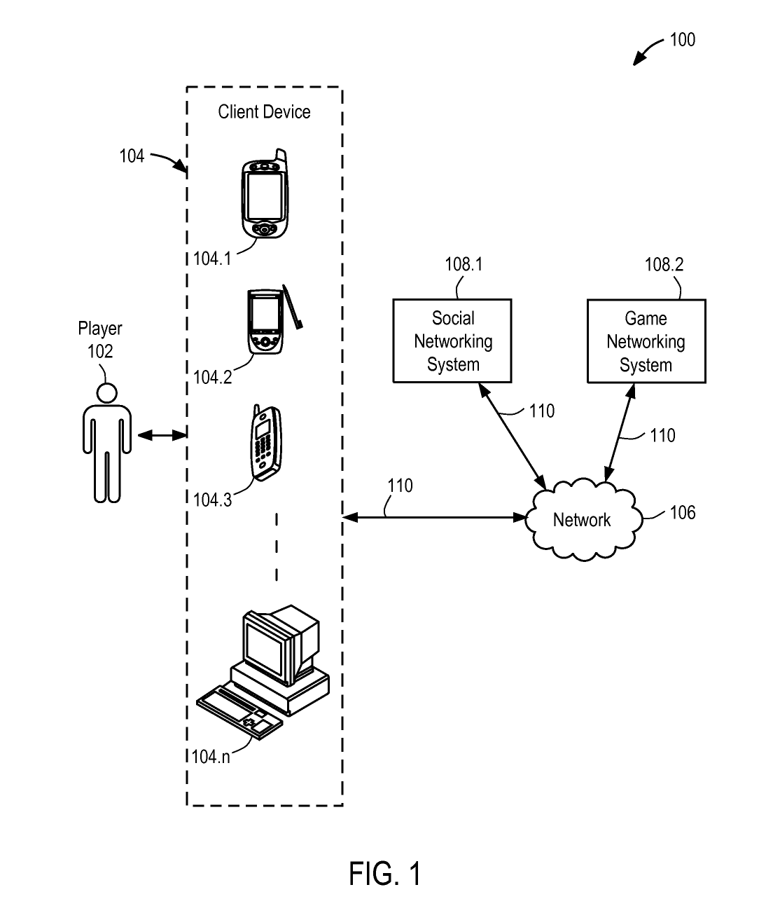

FIG. 1 is a schematic diagram showing an example of a system 100 for implementing various example embodiments. In some embodiments, the system 100 comprises a player 102, a client device 104, a network 106, a social networking system 108.1, and a game networking system 108.2. The components of the system 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client device 104 may access the social networking system 108.1 or the game networking system 108.2 directly, via the network 106, or via a third-party system. For example, the client device 104 may access the game networking system 108.2 via the social networking system 108.1.

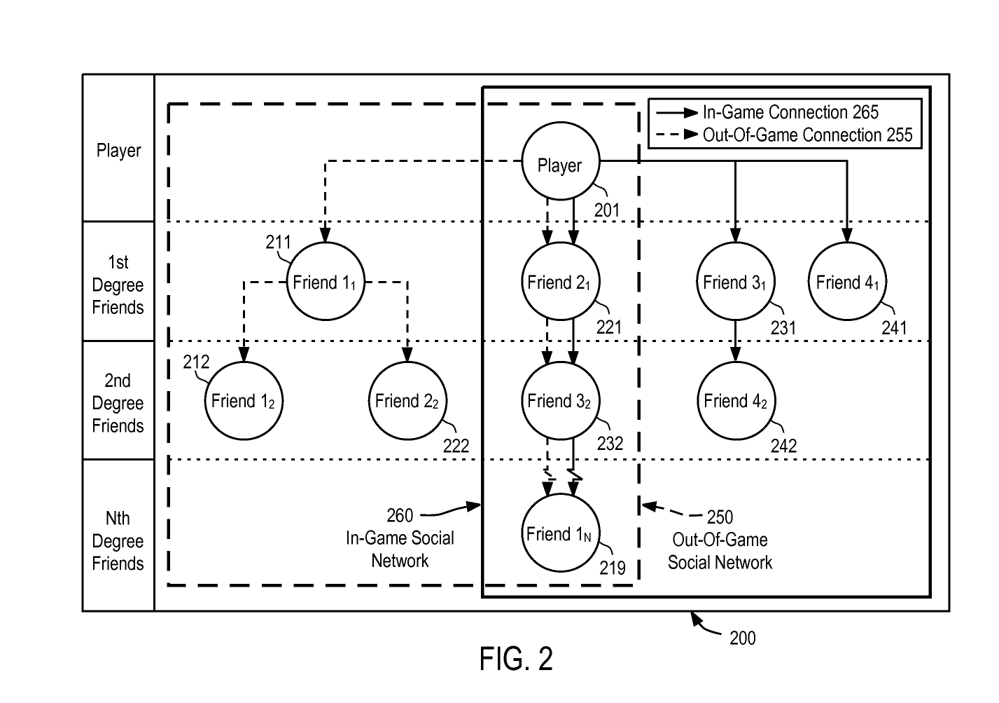

The social networking system 108.1 may include a network-addressable computing system that can host one or more social graphs (see for example FIG. 2), and may be accessed by the other components of system 100 either directly or via the network 106. The social networking system 108.1 may generate, store, receive, and transmit social networking data. Moreover, the game networking system 108.2 may include a network-addressable computing system (or systems) that can host one or more virtual games, for example, online games. The game networking system 108.2 may generate, store, receive, and transmit game-related data, such as, for example, game account data, game input, game state data, and game displays. The game networking system 108.2 may be accessed by the other components of system 100 either directly or via the network 106. The player 102 may use the client device 104 to access, send data to, and receive data from the social networking system 108.1 and/or the game networking system 108.2.

Although FIG. 1 illustrates a particular example of the arrangement of the player 102, the client device 104, the social networking system 108.1, the game networking system 108.2, and the network 106, this disclosure includes any suitable arrangement or configuration of the player 102, the client device 104, the social networking system 108.1, the game networking system 108.2, and the network 106.

FIG. 2 is a schematic diagram showing an example of a social network within a social graph 200. The social graph 200 is shown by way of example to include an out-of-game social network 250, and an in-game social network 260. Moreover, in-game social network 260 may include one or more players that are friends with Player 201 (e.g., Friend 231), and may include one or more other players that are not friends with Player 201. The social graph 200 may correspond to the various players associated with one or more virtual games. In an example embodiment, each player may communicate with other players. When, for example, Player 201 initiates a transfer of a game-related asset to Friend 231, the game networking system 108.2 may perform the transfer of the game-related asset from Player 201 to Friend 231.

### Example Location-Based Leaderboards

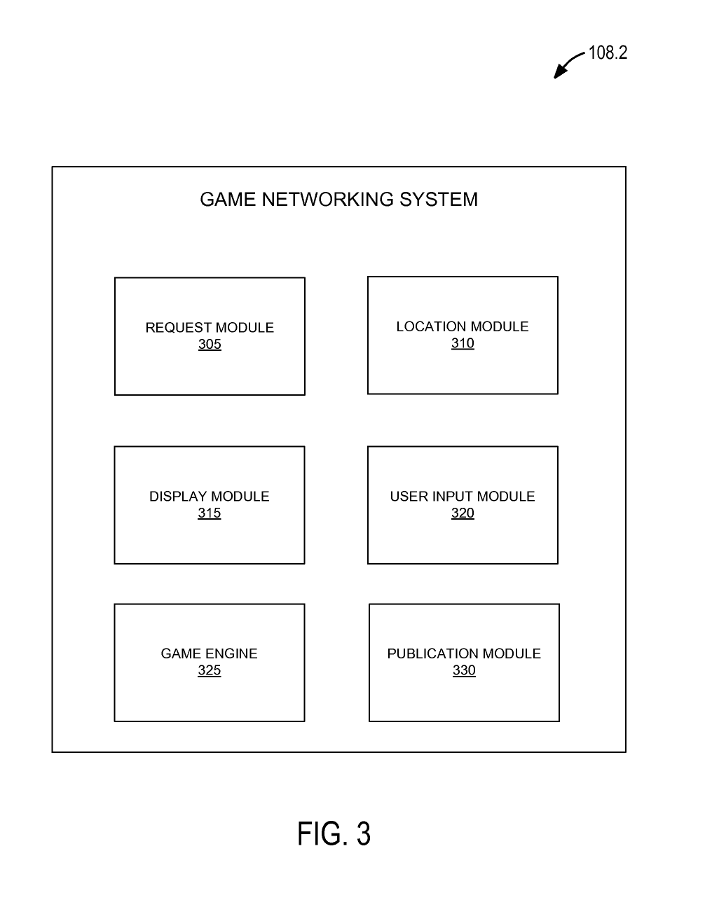

FIG. 3 is a block diagram showing example components of a game networking system 108.2. Game networking system 108.2 may include a request module 305, a location module 310, a display module 315, a user input module 320, a game engine 325, and a publication module 330.

The request module 305 may be a hardware-implemented module which may receive a request from a player to generate a game instance of an online game. In various embodiments, the request to generate the game instance of the online game is a request to play the online game with or against a second player. For example, the player may wish to challenge an opponent. The request may be sent from a client device of the player via the network 106. The request from the player may also include multiple opponents the player would like to challenge. Upon receiving the request, the game networking system 108.2 may forward the request to the game engine 325.

The location module 310 may be a hardware-implemented module which may create and/or determine a game location for the generated game instance of the online game. The game location may be a physical location associated with a location at which the online game is played. In various embodiments, the game location is created by the game server. The game server may use a player's location when creating the game location. Moreover, the player's location may be determined by location information received from the client device, such as GPS location coordinates. The game location may vary in size and may be determined based on any number of location characteristics, such as a street, a building, a city block, a city, a county, a state, a country, or the like. The created game location may correspond to an area around and/or near the player and enclosed within a geographical fence. For example, the game location may correspond to an area within a one mile radius from where the player is currently located. The geographical fence may be indicated by the boundaries of the enclosed area. In various embodiments, the created game location corresponds to a geographical fence around more than one player. In various embodiments, the game location is an existing location stored on a server, such as the game server or any other third party server. The existing location may be presented to the player from the server in a game interface of the online game. Upon viewing the existing location from the game interface, the player may select the existing location as the game location.

In various embodiments, the location module 310 may present a list of game locations to the player. The list of game locations may be represented on a map presented to the player. The list of game locations may be determined based on the location of the player. For example, the list of game locations may be locations within a geographical fence. As stated above, a geographical fence may be used to fence off or enclose a geographical area. The geographical fence may enclose an area including and/or near the player's location. Therefore, the list of game locations may be locations that are near the player. In various embodiments, each of the locations among the list of game locations is retrieved from a third party server, such as Google Maps™. Each of the locations among the list of game locations may also be ranked or arranged in a hierarchy by the location module 310 according to any number and/or combination of relevant factors. For example, the factors may include physical size of the location, amount of game activity at the location, amount of advertising through a game server for a business at the game location, proximity of the game location to a nearby location, and the like.

In various embodiments, the locations among the list of game locations that are physically larger in size are ranked higher than smaller locations. Size of the location may be measured by the amount of area the location covers. Therefore, a city block may be ranked higher than a street. In various embodiments, locations that have more game activity are ranked higher than locations with less game activity. For example, if there are more players playing the online game at the coffee shop as compared to a bakery, then the coffee shop may be ranked higher than the bakery. Game activity may be measured by the amount of game data sent from the location to the game networking system 108.2 via the network 106. Game activity may also be measured by the number of users playing the online game at the location. The amount of game activity at each location among the list of game locations may be displayed. In various embodiments, businesses may spend money to advertise their location as a game location on the game server. This may result in their game location being ranked higher on the list of game locations. Therefore, if the coffee shop spends money on advertising their location as a game location, the coffee shop may be rewarded by being ranked higher on the list of game locations. The advertisements may also specify amenities for playing the online game, such as Wi-Fi capabilities, check-in services, and the like. Moreover, the advertisements may also attract more users to the location, resulting in increased game activity at the location which drives up the ranking of the location. In various embodiments, the ranking of a location may be affected by the proximity of the location to a nearby location. For example, if the coffee shop is determined to be close in proximity to a nearby location and the coffee shop receives more game activity than the nearby location, then the coffee shop may receive a higher ranking and the ranking of the nearby location may drop. Once the game locations have been ranked and presented to the player by the location module 310, a location may be selected by the player from the list to be the game location. Moreover, the information used to rank the locations may be displayed next to each of the locations from the list of game locations. In various embodiments, the list of game locations are presented to the player on a map and, depending on a level of zoom on the map, only a subset comprising of the higher ranked locations are displayed. The zoom setting may correspond to how much area is shown on the map and the greater the area, the higher level of zoom. For example, if the player is viewing the map at a maximum zoom level, such as viewing an entire city at once, then the map may only have room to display one or two locations. The one or two locations may be the first and second ranked locations from the list of game locations. In various embodiments, the first and second ranked locations may be the largest locations and may have the most players or game activity at their locations.

In various embodiments, location module 310 attaches the determined game location to the game instance of the online game. The location module 310 may then send the determined game location to the game engine 325. The game engine 325 may use the game location to verify a player's location before processing game data from the player. In various embodiments, the game location attached to the game instance of the online game can be modified. The location module 310 may receive an indication to increase the size of the game location. For example, the player may want to increase the game location from the coffee shop to an area within a 1 mile radius from the coffee shop. The location module 310 may then modify the size of the game location in response.

The display module 315 may be a hardware-implemented module that may control information or data that is provided to client systems for display on a client device. For example, the display module 315 may be configured to provide display data associated with displaying a game instance of a game, displaying a user interface for selecting a game location, and the like.

The user input module 320 may be a hardware-implemented module that may receive user inputs for processing by the game engine 325 based on rules of the game. For example, the user input module 320 may receive user inputs indicating functions, such as a move made by a player, selections of game locations chosen by a player, and the like.

In various embodiments, the user input module 320 may also receive game data related to the game instance of the online game. In various embodiments, the game data is sent from the client device of the player. The game data may include game metrics to measure and/or indicate a player's progress in the game, such as a player's score, time elapsed in completing a stage of the game, a number of stages completed, and the like. In various embodiments, a game engine 325 will process the game data in order to determine a outcome of the game instance. The outcome of the game instance may indicate information regarding one or more of the players of the game instance, such as whether a player is a winner of the game instance. For example, the winner of the game instance may be determined based on comparing the player's score with the opponent's score. In various embodiments, the game engine 325 will also rank the players based on the game data received from each of the players. For example, game engine 325 may rank the players based on each player's score.

The game engine 325 may be a hardware-implemented module that may control any aspects of a game based on rules of the game, including how a game is played, players' actions and responses to players' actions, and the like. The game engine 325 may be configured to generate the game instance of a game of a player and may determine the progression of a game based on user inputs and rules of the game. In various embodiments, the game engine 325 may generate the game instance of the online game in response to the request received at the request module 305. In various embodiments, the opponent may accept the request from the player before the game instance is generated by the game engine 325.

The publication module 330 may be a hardware-implemented module that may publish and/or present the outcome in a leaderboard so that the leaderboard may display the winner between the player and the opponent. The leaderboard may display information regarding players of the online game. Information may include a player's ranking relative to other players of the online game, a player's game achievements in the online game, a player's location of where the player played the online game, and the like. The players may be listed in the leaderboard according to their ranking. Moreover, the player's ranking may be determined based on the player's game achievements, such as a score, a time elapsed in completing a stage, a number of stages completed, and the like. The publication module 330 may also notify the player if the player's ranking in the leaderboard changes, such as a drop in ranking. In various embodiments, the leaderboard corresponds to the game location. Therefore, information displayed on the leaderboard may be specific to the game location. Further, the leaderboard may be viewed by users currently at the game location or near the game location. In various embodiments, the publication module 330 may publish a global leaderboard which may be viewed by any user, even if the user is not currently near the game location. A list of game locations with the highest scores achieved by players of the game may be displayed in the global leaderboard. The global leaderboard may also display the list of game locations based on the number of high scores at each game location. In various embodiments, if the game location of the leaderboard is a business, such as a coffee shop, the business may provide authorization to allow the leaderboard to be published at the coffee shop. By associating the leaderboard with the business, customers that normally shop at the business may be more likely to view the published leaderboard on their client devices. In addition to the player and the opponent, the leaderboard may also display information on other users who have played the online game at the game location. The leaderboard may also display information on other users currently at the game location playing the online game. For example, the leaderboard may display locations at which the other users are located, game data related to the other users, and the like. In various embodiments, the other users at the game location may include friends of the player or friends of the opponent. In various embodiments, the other users displayed on the leaderboard are also ranked according to the game data. For example, the leaderboard at the coffee shop may display the top ten player scores of the online game. Each of the other users may be displayed on the leaderboard and may be selected to be challenged, and a request may be sent to the request module 305. Moreover, the game engine 325 may send a game reward to each of the top players displayed on the leaderboard. In various embodiments, the business may invite the player to play at their business location for the game reward. The publication module 330 may also filter the information published on the leaderboard according to various schemes. The information published on the leaderboard may be filtered according to time, such as only displaying players that have recently played the online game. Alternatively, the information published may be filtered according to a type of player. For instance, the publication module 330 may only publish users that are friends of the player by accessing the social graph 200 of the player. In various embodiments, the publication module 330 may also publish recommended opponents on the leaderboard. The recommendation may also include a time and a location where the player may challenge the opponent. The recommendation opponents may be determined based on the game location. For example, the recommended opponents may have played the online game at the game location or may be currently nearby the game location.

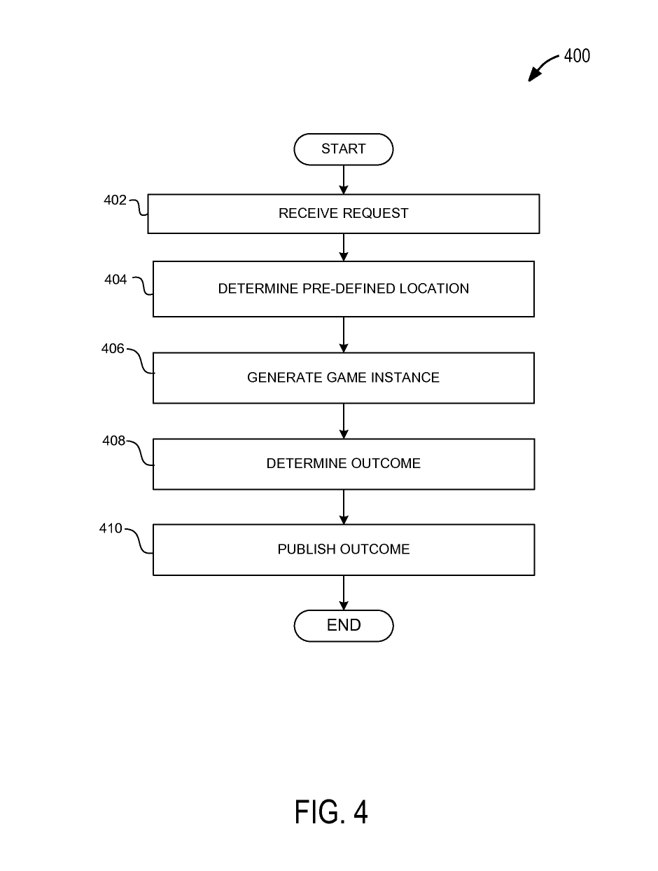

FIG. 4 is a flowchart showing an example method 400 of publishing a location-based leaderboard to a player's mobile device, according to some embodiments. At operation 402 of the method 400, the request module may receive a request from a player operating a client device. In various embodiments, the request is to initiate a game instance of the online game. For example, the player may simply begin playing the online game on the client device. In various embodiments, the request is used to generate a game instance of an online game with another player. In some embodiments, the request may include a location associated with the client device.

At operation 404, the location module may determine a pre-defined location associated with the location of the client device. For example, the location module may use the location associated with the client device to determine the pre-defined location associated with the game instance. In various embodiments, the pre-defined location may be selected by the player from a list of pre-defined locations. The list of pre-defined locations may also be located within a geographical fence enclosing an area near the client device, the location of the client device retrieved from a GPS receiver. The list of pre-defined locations may be displayed to the player on a map and may be ranked according to any number and/or combination of relevant factors. For example, the factors may include physical size of the location, amount of game activity at the location, amount of advertising through a game server for a business at the location, proximity of the location to a nearby location, and the like. Moreover, the list of pre-defined locations may be determined based on the location of the client device. The location module may determine the pre-defined location based on the selection made by the player.

At operation 406, the game engine 325 may generate a game instance in response to the request received by the request module 305. In various embodiments, the opponent may accept the request from the player before the game instance is generated by the game engine 325.

At operation 408, the game engine 325 may determine an outcome associated with the game. In various embodiments, the outcome is determined based on game data received at the game engine. In various embodiments, the game data is sent from the client device and may include game metrics to measure and/or indicate a player's progress in the game, such as a player's score, time elapsed in completing a stage of the game, a number of stages completed, and the like. The outcome determined may include a determination of the player who won the game and the score or some other game-related metric of the winner.

At operation 410, the publication module 330 may publish the outcome of the game instance including publishing the outcome based on the pre-defined location. In various embodiments, the leaderboard corresponds to the pre-defined location and information displayed on the leaderboard may be specific to the pre-defined location. The leaderboard may also display information on the player playing the game at the pre-defined location as well as other players playing the game. For example, the leaderboard may display a winner between two players playing the game at the pre-defined location.

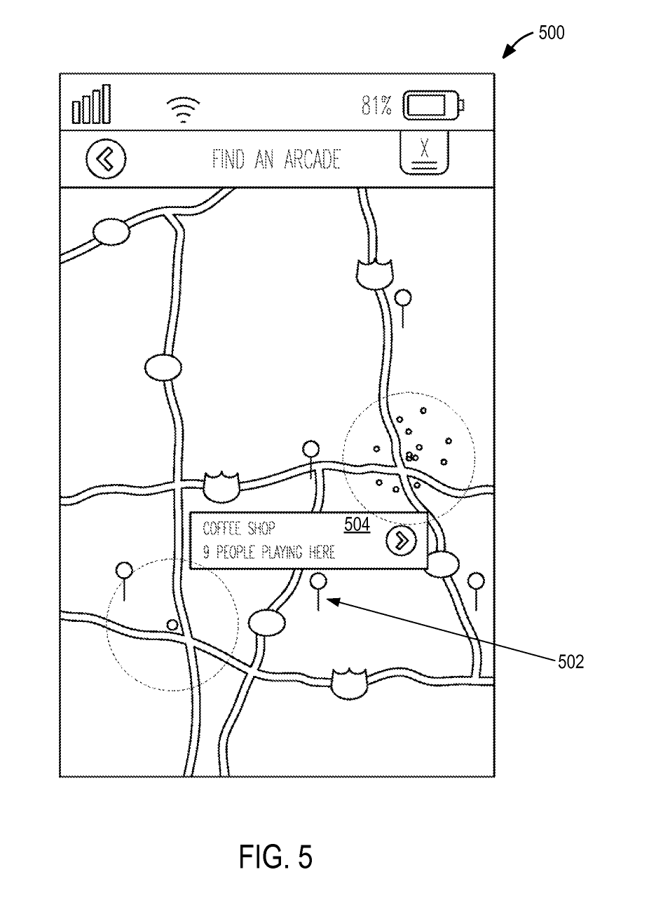

FIG. 5 is a user interface diagram 500 illustrating an example user interface 500 to select a game location from a map, according to some embodiments. Each game location corresponds to a physical location. On the user interface diagram, the game location is indicated by a label 502. Moreover, the label 502 may display information 504 regarding the game location, such as the number of users currently playing at that game location. A user may select a game location from the map. The selected game location may include more than one online game for the user to choose from. In various embodiments, the map may be displayed to the user in response to the user requesting to play a game against a second player. In alternative embodiments, the map may be displayed to the user prior to any request received from the user. Moreover, the map may display locations retrieved from a list of locations that are located within a geographical fence enclosing an area including and/or near the user. As depicted in the user interface diagram 500, the diagram 500 may display locations that are within a predetermined radius from where the user is currently located. In various embodiments, the list of locations may also be ranked so that a subset of the ranked locations is shown on the map. For example, if the map is not large enough to display all of the locations from the list of locations, a subset of the highest ranked locations may be displayed.

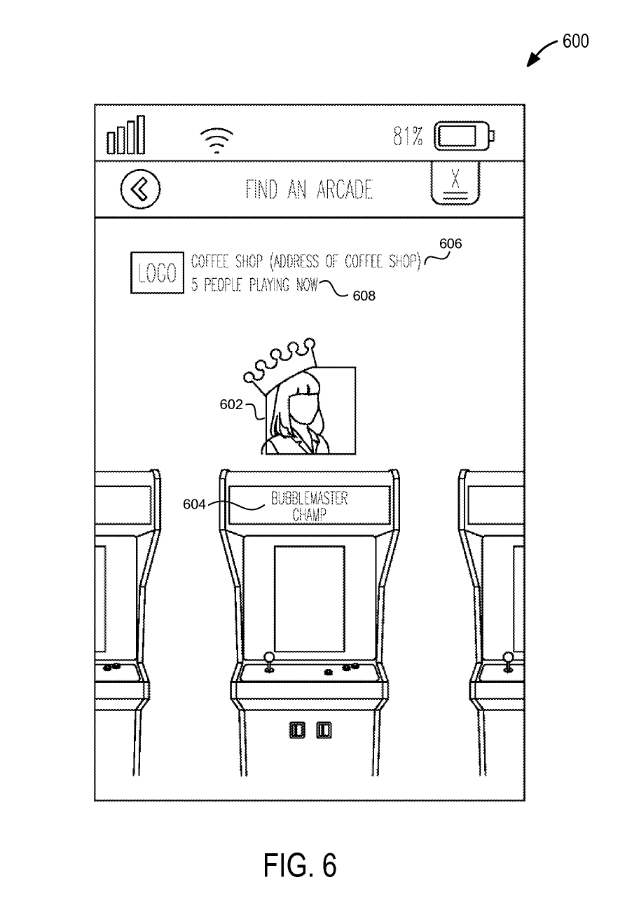

FIG. 6 is a user interface diagram 600 illustrating an example user interface to choose an online game, according to some embodiments. A plurality of online games may be presented to the user, as represented by a picture of an arcade game machine (e.g., online game 604), and the user may choose one of the online games to play by scrolling across the user interface. Further, an icon 602 may be displayed next to each of the online games. The icon 602 may represent a player with the current high score for an online game 604. The user interface may also display the game location 606 attached to the online game as well as statistics regarding the game location 608, such as the number of people playing online game 604 at the coffee shop. As shown in the diagram 600, the online game 604 may be depicted in the user interface as an arcade.

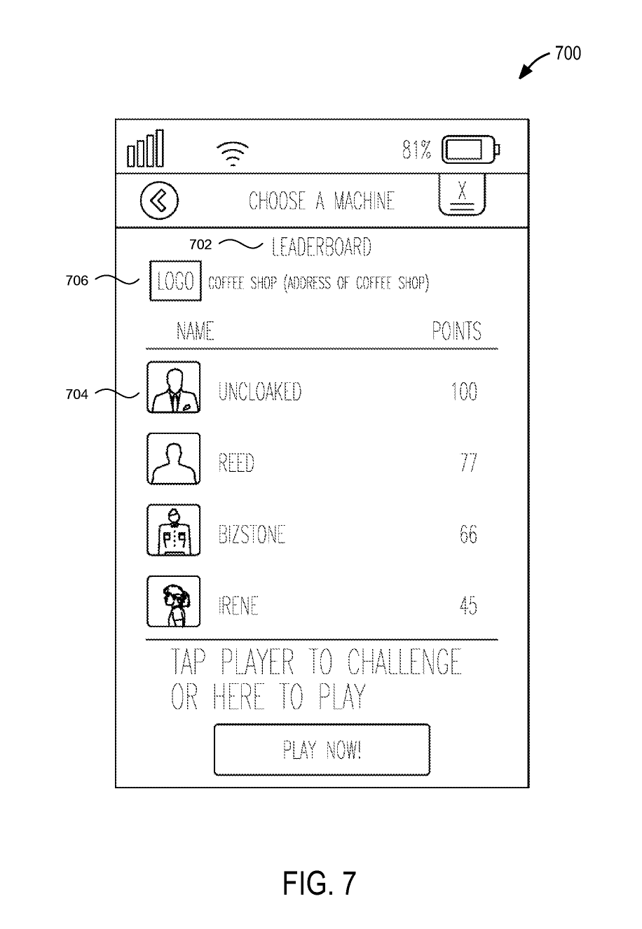

FIG. 7 is an interface diagram 700 illustrating an example user interface of a leaderboard, according to some embodiments. The leaderboard 702 may display information regarding players playing the online game. The players may be ranked according to score. For example, player 704 may be listed at the top of the leaderboard 702 because player 704 has achieved the highest score relative to the other players. Each of the players on the leaderboard may also be referred to by an alias. As depicted in interface diagram 700, player 704 is referred to by the username “uncloaked”. Moreover, each of the players on the leaderboard may be challenged to play the online game. Further, the leaderboard may correspond to a game location, as indicated by the words “Coffee Shop.” Information 706 regarding the game location may also be displayed in the leaderboard 702, such as a logo of the game location, a name of the game location, and an address of the game location.

### Storing Game-Related Data

A database may store any data relating to game play within a game networking system 108.2. The database may include database tables for storing a player game state that may include information about the player's virtual gameboard, the player's character, or other game-related information. For example, player game state may include virtual objects owned or used by the player, placement positions for virtual structural objects in the player's virtual gameboard, and the like. Player game state may also include in-game obstacles of tasks for the player (e.g., new obstacles, current obstacles, completed obstacles, etc.), the player's character attributes (e.g., character health, character energy, amount of coins, amount of cash or virtual currency, etc.), and the like.

The database may also include database tables for storing a player profile that may include user-provided player information that is gathered from the player, the player's client device, or an affiliate social network. The user-provided player information may include the player's demographic information, the player's location information (e.g., a historical record of the player's location during game play as determined via a GPS-enabled device or the internet protocol (IP) address for the player's client device), the player's localization information (e.g., a list of languages chosen by the player), the types of games played by the player, and the like.

In some example embodiments, the player profile may also include derived player information that may be determined from other information stored in the database. The derived player information may include information that indicates the player's level of engagement with the virtual game, the player's friend preferences, the player's reputation, the player's pattern of game-play, and the like. For example, the game networking system 108.2 may determine the player's friend preferences based on player attributes that the player's first-degree friends have in common, and may store these player attributes as friend preferences in the player profile. Furthermore, the game networking system 108.2 may determine reputation-related information for the player based on user-generated content (UGC) from the player or the player's N^{th} degree friends (e.g., in-game messages or social network messages), and may store this reputation-related information in the player profile. The derived player information may also include information that indicates the player's character temperament during game play, anthropological measures for the player (e.g., tendency to like violent games), and the like.

In some example embodiments, the player's level of engagement may be indicated from the player's performance within the virtual game. For example, the player's level of engagement may be determined based on one or more of the following: a play frequency for the virtual game or for a collection of virtual games; an interaction frequency with other players of the virtual game; a response time for responding to in-game actions from other players of the virtual game; and the like.

In some example embodiments, the player's level of engagement may include a likelihood value indicating a likelihood that the player may perform a desired action. For example, the player's level of engagement may indicate a likelihood that the player may choose a particular environment, or may complete a new challenge within a determinable period of time from when it is first presented to him.

In some example embodiments, the player's level of engagement may include a likelihood that the player may be a leading player of the virtual game (a likelihood to lead). The game networking system 108.2 may determine the player's likelihood to lead value based on information from other players that interact with this player. For example, the game networking system 108.2 may determine the player's likelihood to lead value by measuring the other players' satisfaction in the virtual game, measuring their satisfaction from their interaction with the player, measuring the game-play frequency for the other players in relation to their interaction frequency with the player (e.g., the ability for the player to retain others), and/or the like.

The game networking system 108.2 may also determine the player's likelihood to lead value based on information about the player's interactions with others and the outcome of these interactions. For example, the game networking system 108.2 may determine the player's likelihood to lead value by measuring the player's amount of interaction with other players (e.g., as measured by a number of challenges that the player cooperates with others, and/or an elapsed time duration related thereto), the player's amount of communication with other players, the tone of the communication sent or received by the player, and/or the like. Moreover, the game networking system 108.2 may determine the player's likelihood to lead value based on determining a likelihood for the other players to perform a certain action in response to interacting or communicating with the player and/or the player's virtual environment.

### Example Game Systems, Social Networks, and Social Graphs

In a multiplayer game, players control player characters (PCs), a game engine controls non-player characters (NPCs), and the game engine also manages player character state and tracks states for currently active (e.g., online) players and currently inactive (e.g., offline) players. A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a player (or a group of more than one players), the game engine may take into account the state of the player character (or group of PCs) that is playing, but also the state of one or more PCs of offline/inactive players who are connected to the current player (or PC, or group of PCs) through the game social graph but are not necessarily involved in the game at the time.

For example, Player A with six friends on Player A's team (e.g., the friends that are listed as being in the player's mob/gang/set/army/business/crew/etc. depending on the nature of the game) may be playing the virtual game and choose to confront Player B who has 20 friends on Player B's team. In some embodiments, a player may only have first-degree friends on the player's team. In other embodiments, a player may also have second-degree and higher degree friends on the player's team. To resolve the game event, in some embodiments the game engine may total up the weapon strength of the seven members of Player A's team and the weapon strength of the 21 members of Player B's team and decide an outcome of the confrontation based on a random variable applied to a probability distribution that favors the side with the greater total. In some embodiments, all of this may be done without any other current active participants other than Player A (e.g., Player A's friends, Player, B, and Player B's friends could all be offline or inactive). In some embodiments, the friends in a player's team may see a change in their state as part of the outcome of the game event. In some embodiments, the state (assets, condition, level) of friends beyond the first degree are taken into account.

### Example Game Networking Systems

A virtual game may be hosted by the game networking system 108.2, which can be accessed using any suitable connection 110 with a suitable client device 104. A player may have a game account on the game networking system 108.2, wherein the game account may contain a variety of information associated with the player (e.g., the player's personal information, financial information, purchase history, player character state, game state, etc.). In some embodiments, a player may play multiple games on the game networking system 108.2, which may maintain a single game account for the player with respect to the multiple games, or multiple individual game accounts for each game with respect to the player. In some embodiments, the game networking system 108.2 may assign a unique identifier to a player 102 of a virtual game hosted on the game networking system 108.2. The game networking system 108.2 may determine that the player 102 is accessing the virtual game by reading the user's cookies, which may be appended to HTTP requests transmitted by the client device 104, and/or by the player 102 logging onto the virtual game.

In some embodiments, the player 102 accesses a virtual game and controls the game's progress via the client device 104 (e.g., by inputting commands to the game at the client device 104). The client device 104 can display the game interface, receive inputs from the player 102, transmit user inputs or other events to the game engine, and receive instructions from the game engine. The game engine can be executed on any suitable system (such as, for example, the client device 104, the social networking system 108.1, or the game networking system 108.2). For example, the client device 104 may download client components of a virtual game, which are executed locally, while a remote game server, such as the game networking system 108.2, provides backend support for the client components and may be responsible for maintaining application data of the game, processing the inputs from the player 102, updating and/or synchronizing the game state based on the game logic and each input from the player 102, and transmitting instructions to the client device 104. As another example, when the player 102 provides an input to the game through the client device 104 (such as, for example, by typing on the keyboard or clicking the mouse of the client device 104), the client components of the game may transmit the player's input to the game networking system 108.2.

In some embodiments, the player 102 accesses particular game instances of a virtual game. A game instance is a copy of a specific game play area that is created during runtime. In some embodiments, a game instance is a discrete game play area where one or more players 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific players. A game instance is associated with a specific player when one or more game parameters of the game instance are associated with the specific player. For example, a game instance associated with a first player may be named “First Player's Play Area.” This game instance may be populated with the first player's PC and one or more in-game objects associated with the first player.

In some embodiments, a game instance associated with a specific player is only accessible by that specific player. For example, a first player may access a first game instance when playing a virtual game, and this first game instance may be inaccessible to all other players. In other embodiments, a game instance associated with a specific player is accessible by one or more other players, either synchronously or asynchronously with the specific player's game play. For example, a first player may be associated with a first game instance, but the first game instance may be accessed by all first-degree friends in the first player's social network.

In some embodiments, the set of in-game actions available to a specific player is different in a game instance that is associated with this player compared to a game instance that is not associated with this player. The set of in-game actions available to a specific player in a game instance associated with this player may be a subset, superset, or independent of the set of in-game actions available to this player in a game instance that is not associated with him. For example, a first player may be associated with Blackacre Farm in an online farming game, and may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In some embodiments, a game engine interfaces with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a player or player character in a multiplayer game.

In some embodiments, the social graph is managed by the game networking system 108.2, which is managed by the game operator. In other embodiments, the social graph is part of a social networking system 108.1 managed by a third party (e.g., Facebook, Friendster, Myspace). In yet other embodiments, the player 102 has a social network on both the game networking system 108.2 and the social networking system 108.1, wherein the player 102 can have a social network on the game networking system 108.2 that is a subset, superset, or independent of the player's social network on the social networking system 108.1. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 108.1, the game networking system 108.2, or both.

### Example Systems and Methods

Returning to FIG. 2, the Player 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to Player 201. As used herein, the terms “player” and “user” can be used interchangeably and can refer to any user in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In social graph 200, it is possible for individuals to be connected to other individuals through their first-degree friends (e.g., friends of friends). As described above, the number of edges in a minimum path that connects a player to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.1.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a player (or player character) has a social graph within a multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a player's in-game social network is formed both explicitly (e.g., when users “friend” each other) and implicitly (e.g., when the system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (e.g., in disintermediated interactions or the like), but that could be the case.

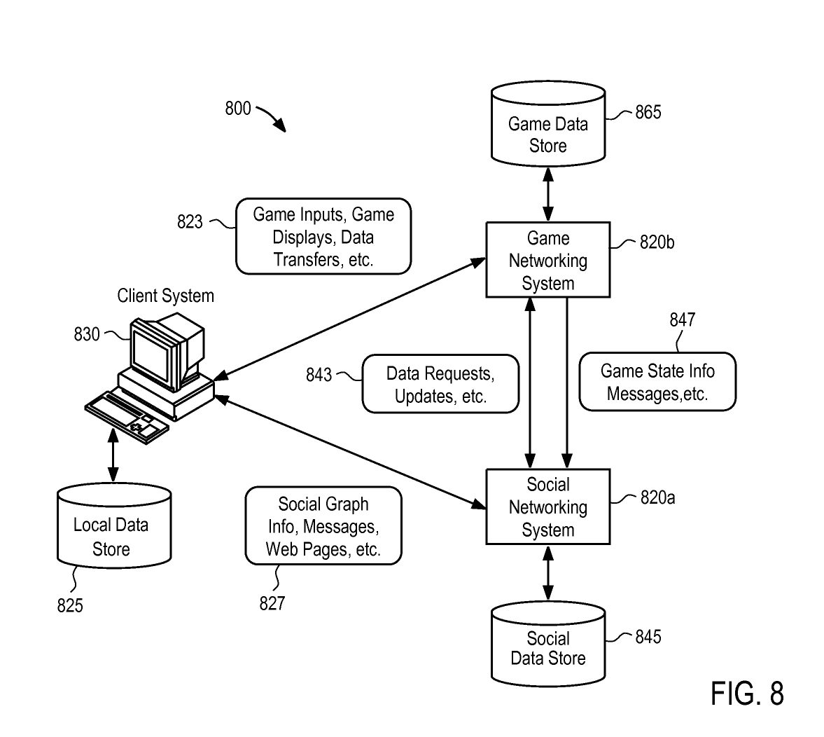

FIG. 8 is a diagrammatic representation of an example data flow between example components of an example system 800. One or more of the components of the example system 800 may correspond to one or more of the components of the example system 100. In some embodiments, system 800 includes a client system 830, a social networking system 820a, and a game networking system 820b. The components of system 800 can be connected to each other in any suitable configuration, using any suitable type of connection. The components may be connected directly or over any suitable network. The client system 830, the social networking system 820a, and the game networking system 820b may have one or more corresponding data stores such as the local data store 825, the social data store 845, and the game data store 865, respectively.

The client system 830 may receive and transmit data 823 to and from the game networking system 820b. This data can include, for example, a web page, a message, a game input, a game display, a HTTP packet, a data request, transaction information, and other suitable data. At some other time, or at the same time, the game networking system 820b may communicate data 843, 847 (e.g., game state information, game system account information, page info, messages, data requests, updates, etc.) with other networking systems, such as the social networking system 820a (e.g., FACEBOOK, MYSPACE, etc.). The client system 830 can also receive and transmit data 827 to and from the social networking system 820a. This data can include, for example, web pages, messages, social graph information, social network displays, HTTP packets, data requests, transaction information, updates, and other suitable data.

Communication between the client system 830, the social networking system 820a, and the game networking system 820b can occur over any appropriate electronic communication medium or network using any suitable communications protocols. For example, the client system 830, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a player accesses a virtual game on the game networking system 820b, the BLOB containing the game state for the instance corresponding to the player may be transmitted to the client system 830 for use by a client-side executed object to process. In some embodiments, the client-side executable is a FLASH™-based game, which can de-serialize the game state data in the BLOB. As a player plays the game, the game logic implemented at the client system 830 maintains and modifies the various game state parameters locally. The client-side game logic may also batch game events, such as mouse clicks, and transmit these events to the game networking system 820b. Game networking system 820b may itself operate by retrieving a copy of the BLOB from a database or an intermediate memory cache (memcache) layer. The game networking system 820b can also de-serialize the BLOB to resolve the game state parameters and execute its own game logic based on the events in the batch file of events transmitted by the client to synchronize the game state on the server side. The game networking system 820b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a player selects one or more actions to perform. The web pages may be displayed in a browser client executed on the client system 830. For example, a client application downloaded to the client system 830 may operate to serve a set of web pages to a player. As another example, a virtual game may be an animated or rendered game executable as a stand-alone application or within the context of a webpage or other structured document. In some embodiments, the virtual game is implemented using ADOBE™ FLASH™-based technologies. As an example, a game may be fully or partially implemented as a SWF object that is embedded in a web page and executable by a FLASH™ media player plug-in. In some embodiments, one or more described web pages are associated with or accessed by the social networking system 820a. This disclosure contemplates using any suitable application for the retrieval and rendering of structured documents hosted by any suitable network-addressable resource or website.

Application event data of a game is any data relevant to the game (e.g., player inputs). In some embodiments, each application datum may have a name and a value, and the value of the application datum may change (e.g., be updated) at any time. When an update to an application datum occurs at the client system 830, either caused by an action of a game player or by the game logic itself, the client system 830 may need to inform the game networking system 820b of the update. For example, if the game is a farming game with a harvest mechanic (such as ZYNGA™ FARMVILLE™), an event can correspond to a player clicking on a parcel of land to harvest a crop. In such an instance, the application event data may identify an event or action (e.g., harvest) and an object in the game to which the event or action applies.

In some embodiments, one or more objects of a game may be represented as any one of an ADOBE™ FLASH™ object, MICROSOFT™ SILVERLIGHT™ object, HTML 5 object, etc. FLASH™ may manipulate vector and raster graphics, and supports bidirectional streaming of audio and video. “FLASH™” may mean the authoring environment, the player, or the application files. In some embodiments, the client system 830 may include a FLASH™ client. The FLASH™ client may be configured to receive and run FLASH™ application or game object code from any suitable networking system (such as, for example, the social networking system 820a or the game networking system 820b). In some embodiments, the FLASH™ client is run in a browser client executed on the client system 830. A player can interact with FLASH™ objects using the client system 830 and the FLASH™ client. The FLASH™ objects can represent a variety of in-game objects. Thus, the player may perform various in-game actions on various in-game objects by making various changes and updates to the associated FLASH™ objects.

In some embodiments, in-game actions are initiated by clicking or similarly interacting with a FLASH™ object that represents a particular in-game object. For example, a player can interact with a FLASH™ object to use, move, rotate, delete, attack, shoot, or harvest an in-game object. This disclosure contemplates performing any suitable in-game action by interacting with any suitable FLASH™ object. In some embodiments, when the player makes a change to a FLASH™ object representing an in-game object, the client-executed game logic may update one or more game state parameters associated with the in-game object. To ensure synchronization between the FLASH™ object shown to the player at the client system 830, the FLASH™ client may send the events that caused the game state changes to the in-game object to the game networking system 820b. However, to expedite the processing and hence the speed of the overall gaming experience, the FLASH™ client may collect a batch of some number of events or updates into a batch file. The number of events or updates may be determined by the FLASH™ client dynamically or determined by the game networking system 820b based on server loads or other factors. For example, client system 830 may send a batch file to the game networking system 820b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to player data or metadata, changes to player social connections or contacts, player inputs to the game, and events generated by the game logic. In some embodiments, each application datum has a name and a value. The value of an application datum may change at any time in response to the game play of a player or in response to the game engine (e.g., based on the game logic). In some embodiments, an application data update occurs when the value of a specific application datum is changed.

In some embodiments, when a player plays a virtual game on the client system 830, the game networking system 820b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular player and a particular virtual game. In some embodiments, while a player is not playing the virtual game, the corresponding BLOB may be stored in the database. This enables a player to stop playing the game at any time without losing the current state of the game the player is in. When a player resumes playing the game next time, game networking system 820b may retrieve the corresponding BLOB from the database to determine the most-recent values of the game-related data. In some embodiments, while a player is playing the virtual game, the game networking system 820b also loads the corresponding BLOB into a memory cache so that the game system may have faster access to the BLOB and the game-related data contained therein.

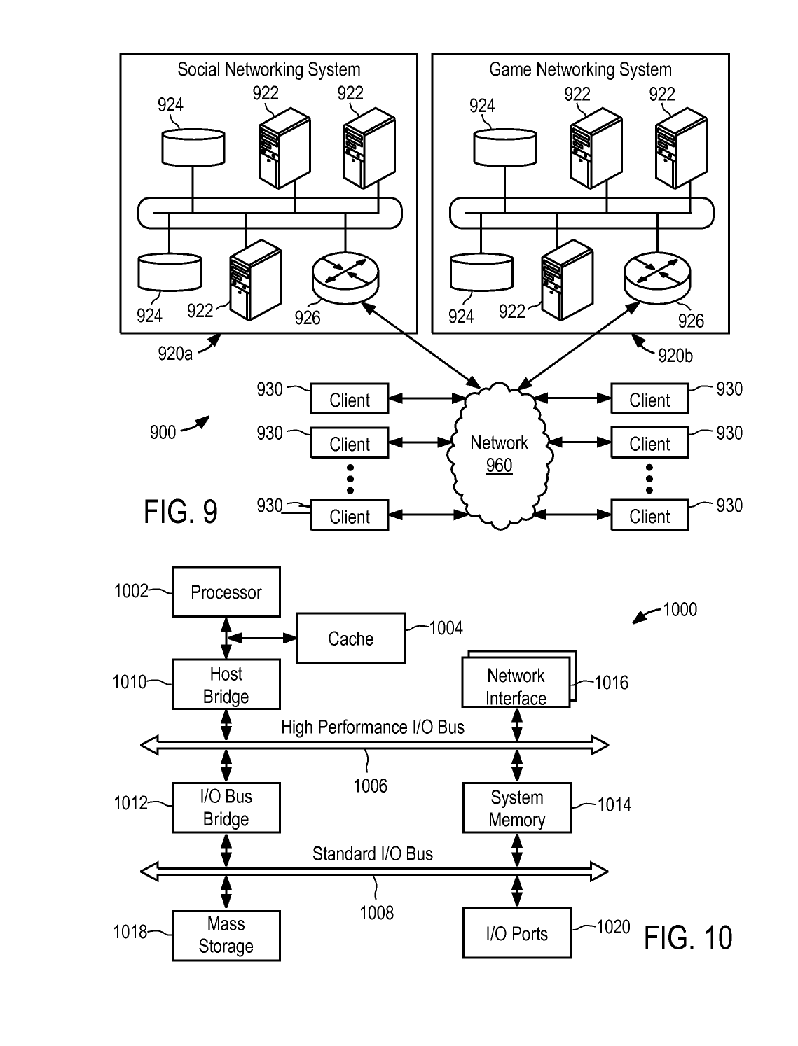

Various embodiments may operate in a wide area network environment, such as the Internet, including multiple network addressable systems. FIG. 9 is a schematic diagram showing an example network environment 900, in which various example embodiments may operate. Network cloud 960 generally represents one or more interconnected networks, over which the systems and hosts described herein can communicate. Network cloud 960 may include packet-based wide area networks (such as the Internet), private networks, wireless networks, satellite networks, cellular networks, paging networks, and the like. As FIG. 9 illustrates, various embodiments may operate in a network environment 900 comprising one or more networking systems, such as a social networking system 920a, a game networking system 920b, and one or more client systems 930. The components of the social networking system 920a and the game networking system 920b operate analogously; as such, hereinafter they may be referred to simply as the networking system 920. The client systems 930 are operably connected to the network environment 900 via a network service provider, a wireless carrier, or any other suitable means.

The networking system 920 is a network addressable system that, in various example embodiments, comprises one or more physical servers 922 and data stores 924. The one or more physical servers 922 are operably connected to computer network cloud 960 via, by way of example, a set of routers and/or networking switches 926. In an example embodiment, the functionality hosted by the one or more physical servers 922 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), FLASH™, ActionScript, and the like.

The physical servers 922 may host functionality directed to the operations of the networking system 920. Hereinafter servers 922 may be referred to as server 922, although the server 922 may include numerous servers hosting, for example, the networking system 920, as well as other content distribution servers, data stores, and databases. Data store 924 may store content and data relating to, and enabling, operation of, the networking system 920 as digital data objects. A data object, in some embodiments, is an item of digital information typically stored or embodied in a data file, database, or record. Content objects may take many forms, including: text (e.g., ASCII, SGML, HTML), images (e.g., JPEG, TIF and GIF), graphics (vector-based or bitmap), audio, video (e.g., MPEG), or other multimedia, and combinations thereof. Content object data may also include executable code objects (e.g., games executable within a browser window or frame), podcasts, etc.

Logically, data store 924 corresponds to one or more of a variety of separate and integrated databases, such as relational databases and object-oriented databases, that maintain information as an integrated collection of logically related records or files stored on one or more physical systems. Structurally, data store 924 may generally include one or more of a large class of data storage and management systems. In some embodiments, data store 924 may be implemented by any suitable physical system(s) including components, such as one or more database servers, mass storage media, media library systems, storage area networks, data storage clouds, and the like. In one example embodiment, data store 924 includes one or more servers, databases (e.g., MySQL), and/or data warehouses. Data store 924 may include data associated with different networking system 920 users and/or client systems 930.

The client system 930 is generally a computer or computing device including functionality for communicating (e.g., remotely) over a computer network. The client system 930 may be a desktop computer, laptop computer, personal digital assistant (PDA), in- or out-of-car navigation system, smart phone or other cellular or mobile phone, or mobile gaming device, among other suitable computing devices. Client system 930 may execute one or more client applications, such as a Web browser.

When a user at a client system 930 desires to view a particular webpage (hereinafter also referred to as target structured document) hosted by the networking system 920, the user's web browser, or other document rendering engine or suitable client application, formulates and transmits a request to the networking system 920. The request generally includes a URL or other document identifier as well as metadata or other information. By way of example, the request may include information identifying the user, a timestamp identifying when the request was transmitted, and/or location information identifying a geographic location of the user's client system 930 or a logical network location of the user's client system 930.

Although the example network environment 900 described above and illustrated in FIG. 9 is described with respect to the social networking system 920a and the game networking system 920b, this disclosure encompasses any suitable network environment using any suitable systems. For example, a network environment may include online media systems, online reviewing systems, online search engines, online advertising systems, or any combination of two or more such systems.

FIG. 10 is a block diagram illustrating an example computing system architecture, which may be used to implement a server 922 or a client system 930. In one embodiment, the hardware system 1000 comprises a processor 1002, a cache memory 1004, and one or more executable modules and drivers, stored on a tangible computer-readable storage medium, directed to the functions described herein. Additionally, the hardware system 1000 may include a high performance input/output (I/O) bus 1006 and a standard I/O bus 1008. A host bridge 1010 may couple the processor 1002 to the high performance I/O bus 1006, whereas the I/O bus bridge 1012 couples the two buses 1006 and 1008 to each other. A system memory 1014 and one or more network/communication interfaces 1016 may couple to the bus 1006. The hardware system 1000 may further include video memory (not shown) and a display device coupled to the video memory. Mass storage 1018 and I/O ports 1020 may couple to the bus 1008. The hardware system 1000 may optionally include a keyboard, a pointing device, and a display device (not shown) coupled to the bus 1008. Collectively, these elements are intended to represent a broad category of computer hardware systems.

The elements of the hardware system 1000 are described in greater detail below. In particular, the network interface 1016 provides communication between the hardware system 1000 and any of a wide range of networks, such as an Ethernet (e.g., IEEE 802.3) network, a backplane, etc. The mass storage 1018 provides permanent storage for the data and programming instructions to perform the above-described functions implemented in servers 922 of FIG. 9, whereas system memory 1014 (e.g., DRAM) provides temporary storage for the data and programming instructions when executed by the processor 1002. I/O ports 1020 are one or more serial and/or parallel communication ports that provide communication between additional peripheral devices, which may be coupled to the hardware system 1000.

The hardware system 1000 may include a variety of system architectures and various components of the hardware system 1000 may be rearranged. For example, cache memory 1004 may be on-chip with the processor 1002. Alternatively, the cache memory 1004 and the processor 1002 may be packed together as a “processor module,” with processor 1002 being referred to as the “processor core.” Furthermore, certain embodiments of the present disclosure may neither require nor include all of the above components. For example, the peripheral devices shown coupled to the standard I/O bus 1008 may couple to the high performance I/O bus 1006. In addition, in some embodiments, only a single bus may exist, with the components of the hardware system 1000 being coupled to the single bus. Furthermore, the hardware system 1000 may include additional components, such as additional processors, storage devices, or memories.

An operating system manages and controls the operation of the hardware system 1000, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A system comprising:
a hardware-implemented request module configured to receive a request to play a game against a second player, the request being received from a first client device of a first player and including a location of the first client device;
a hardware-implemented location module configured to determine a pre-defined location associated with the location of the first client device;
a hardware-implemented game engine configured to:
generate a game instance of the game in response to the request; and
determine an outcome associated with the game; and
a hardware-implemented publication module configured to publish the outcome of the game instance including publishing the outcome based on the pre-defined location.

2. The system of claim 1, wherein the hardware-implemented location module is further configured to present a list of pre-defined locations to the first player and determine the pre-defined location based on a selection from the list of pre-defined locations.

3. The system of claim 2, wherein the hardware-implemented location module is further configured to order the list of pre-defined locations based on at least one of: physical size of each pre-defined location, amount of game activity at each pre-defined location, amount of advertising for each pre-defined location, and proximity of each pre-defined location to a nearby location.

4. The system of claim 2, wherein the list of pre-defined locations includes pre-defined locations near the player and within an area enclosed by a geographical fence.

5. The system of claim 1, wherein the pre-defined location is indicated by at least one of the following location characteristics: a street, a building, a city block, a city, a county, a state, or a country.

6. The system of claim 1, wherein the hardware-implemented publication module is further configured to publish the outcome of the game instance in a leaderboard, the leaderboard displaying information relevant to the pre-defined location.

7. The system of claim 1 further comprising:
a hardware-implemented user input module configured to receive game data from the first client device, wherein the game data includes game metrics indicating progress of the first player in the game.

8. The system of claim 7, wherein the hardware-implemented game engine is further configured to rank the first player as compared to other players of the game based on the game data received from the first client device.

9. The system of claim 8, wherein the hardware-implemented publication module is further configured to publish the rank of the first player based on the pre-defined location.

10. The system of claim 1, wherein the hardware-implemented request module is further configured to receive a request to play the game with another user at the pre-defined location.

11. A method comprising:
receiving, by a game networking system, a request to play a game against a second player, the request being received from a first client device of a first player and including a location of the first client device;
determining, by a game networking system, a pre-defined location associated with the location of the first client device;
generating, by a game networking system, a game instance of the game in response to the request;
determining, by a game networking system, an outcome associated with the game; and
publishing, by a game networking system, the outcome of the game instance including publishing the outcome based on the pre-defined location.

12. The method of claim 11, wherein determining a pre-defined location associated with the location of the first client device further comprises:
presenting, by a game networking system, a list of pre-defined locations to the first player; and
determining, by a game networking system, the pre-defined location based on a selection from the list of pre-defined locations.

13. The method of claim 12, wherein the list of pre-defined locations is ordered based on at least one of: physical size of each pre-defined location, amount of game activity at each pre-defined location, amount of advertising for each pre-defined location, and proximity of each pre-defined location to a nearby location.

14. The method of claim 12, wherein the list of pre-defined locations includes pre-defined locations near the player and within an area enclosed by a geographical fence.

15. The method of claim 11, wherein the pre-defined location is indicated by at least one of the following location characteristics: a street, a building, a city block, a city, a county, a state, or a country.

16. The method of claim 11, further comprising:
publishing, by a game networking system, the outcome of the game instance in a leaderboard, the leaderboard displaying information relevant to the pre-defined location.

17. The method of claim 11, further comprising:
receiving, by a game networking system, game data from the first client device, wherein the game data includes game metrics indicating progress of the first player in the game.

18. The method of claim 17, wherein the first player is ranked as compared to other players of the game based on the game data received from the first client device.

19. The method of claim 11, further comprising:
receiving, by a game networking system, a request to play the game with another player at the pre-defined location.

20. A non-transitory machine-readable medium storing instructions which, when executed by one or more processors, cause the one or more processors to perform operations comprising:
receiving a request to play a game against a second player, the request being received from a first client device of a first player and including a location of the first client device;
determining a pre-defined location associated with the location of the first client device;
generating a game instance of the game in response to the request;
determining an outcome associated with the game; and
publishing the outcome of the game instance including publishing the outcome based on the pre-defined location.
